(19) United States
(12) Patent Application Publication
(10) Pub. No.: US 2025/0243120 A1
(43) Pub. Date: Jul. 31, 2025

(54) FLUORINE RESISTANT COMPOSITIONS

(71) Applicant: Applied Materials, Inc., Santa Clara, CA (US)

(72) Inventors: Katherine WOO, Santa Clara, CA (US); Jennifer Y. SUN, Mountain View, CA (US)

(21) Appl. No.: 18/670,144

(22) Filed: May 21, 2024

Related U.S. Application Data
(60) Provisional application No. 63/624,991, filed on Jan. 25, 2024.

(51) Int. Cl. C04B 35/10

(52) U.S. Cl. CPC C04B 35/10; C04B 2235/3205; C04B 2235/3217; C04B 2235/3225; C04B 2235/445; C04B 2235/9692

(57) ABSTRACT

The present disclosure generally provides a fluorine resistant ceramic composition. The fluorine resistant ceramic composition includes about 80 mol % to about 99.9 mol % of a first metal composition including an aluminum based composition selected from the group consisting of a nitride, oxynitride, oxide, and oxy-fluoride. The fluorine resistant ceramic composition includes about 0.1 mol % to about 20 mol % of a second metal composition including an alkaline-earth metal based composition selected from the group consisting of a nitride, oxynitride, oxide, oxy-fluoride, and fluoride.

### CROSS-REFERENCE TO RELATED APPLICATION

This application claims benefit and priority to U.S. Provisional Application No. 63/624,991, filed Jan. 25, 2024, the entirety of which is incorporated herein.

### BACKGROUND

### Field

Embodiments of the present disclosure generally relate to semiconductor processing. More specifically, embodiments relate to fluorine resistant substrate supports.

### Description of the Related Art

Various semiconductor processing techniques implement one or more ceramic components that are subject to harsh chemical conductions during high temperature NF₃ plasma processing techniques. Conventional ceramic components used in high temperature NF₃ plasma processing techniques are formed by a bulk material including doped and/or undoped aluminum nitride or aluminum oxide. Unfortunately, each of the doped and/or undoped aluminum nitride or aluminum oxide can degrade due to fluorination and/or thermal shock.

Conventional approaches to prevent degradation of ceramic components in processing chambers has focused on coating the bulk material with a fluorine resistant coating. Unfortunately, the fluorine resistant coatings can crack and/or delaminate during processing, which can lead to particle contamination during substrate processing. Moreover, the cracking and/or delamination of the fluorine resistant coating requires complex regeneration processes to correct the cracks, thereby increasing downtime and manufacturing costs.

Therefore, improved ceramic compositions are needed.

### SUMMARY

In some embodiments, the present disclosure provides a fluorine resistant ceramic composition. The fluorine resistant ceramic composition includes about 80 mol % to about 99.9 mol % of a first metal composition including an aluminum based composition selected from the group consisting of a nitride, oxynitride, oxide, and oxy-fluoride. The fluorine resistant ceramic composition includes about 0.1 mol % to about 20 mol % of a second metal composition including an alkaline-earth metal based composition selected from the group consisting of a nitride, oxynitride, oxide, oxy-fluoride, and fluoride.

In other embodiments, the present disclosure provides a fluorine resistant ceramic composition. The fluorine resistant ceramic composition includes about 0.1 mol % to about 40 mol % of a first metal composition including an aluminum based composition selected from the group consisting of a nitride, oxynitride, oxide, and oxy-fluoride. The fluorine resistant ceramic composition includes about 55 mol % to about 99.9 mol % of a second metal composition including an alkaline-earth metal based composition selected from the group consisting of a nitride, oxynitride, oxide, oxy-fluoride, and fluoride. The fluorine resistant ceramic composition includes about 0 mol % to about 40 mol % of a third metal composition including a rare-earth metal based composition selected from the group consisting of a nitride, oxynitride, oxide, oxy-fluoride, and fluoride. The composition includes about 0.1 mol % to about 40 mol % of the third metal composition when the composition includes about 15 mol % to about 40 mol % of the first metal composition. The combination of the first metal composition, second metal composition, and third metal composition does not exceed 100 mol %.

In other embodiments, the present disclosure provides a ceramic component including a ceramic composition. The ceramic composition includes about 0.1 mol % to about 40 mol % of a first metal composition including an aluminum based composition selected from the group consisting of a nitride, oxynitride, oxide, and oxy-fluoride. The ceramic composition includes about 55 mol % to about 99.9 mol % of a second metal composition including an alkaline-earth metal based composition selected from the group consisting of a nitride, oxynitride, oxide, oxy-fluoride, and fluoride. The ceramic composition includes about 0 mol % to about 40 mol % of a third metal composition including a rare-earth metal based composition selected from the group consisting of a nitride, oxynitride, oxide, oxy-fluoride, and fluoride. The ceramic composition includes about 0.1 mol % to about 40 mol % of the third metal composition when the composition includes about 15 mol % to about 40 mol % of the first metal composition. The combination of the first metal composition, second metal composition, and third metal composition does not exceed 100 mol %.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a schematic, side view of a processing chamber, according to embodiments of the disclosure.

FIG. 2 is a diagram illustrating a ceramic composition, according to embodiments of the disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to ceramic compositions and methods of production thereof for use as a bulk material of a ceramic component in a high temperature NF₃ plasma processing chamber. In some embodiments, the ceramic compositions can include a binary and/or a ternary oxide composition. In some embodiments, the binary and/or ternary oxide composition can include one or more of a nitride, oxynitride, oxide, fluoride, and/or oxy-fluoride. In some embodiments, the binary and/or ternary oxide composition can provide increased fluorine resistance compared to conventional bulk material compositions, e.g., aluminum nitride and/or aluminum oxide, thereby providing increased longevity for the ceramic composition.

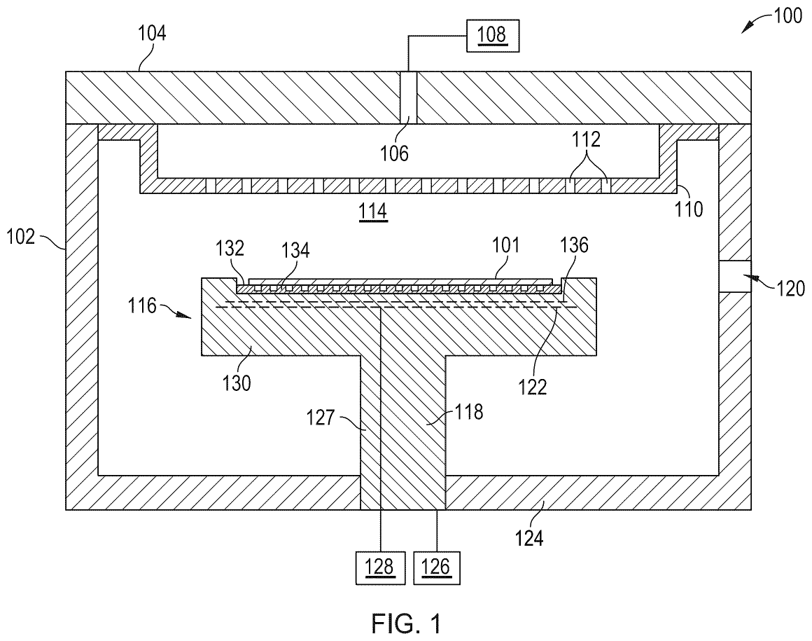

FIG. 1 illustrates a schematic view of a process chamber 100 according to some embodiments of the disclosure. The process chamber 100 includes a chamber body 102 and a lid 104 defining a process volume 114 therein. A bottom 124 of the chamber body 102 is opposite the lid 104. A port 106 is formed through the lid 104. A gas source 108 is in fluid communication with the port 106. A showerhead 110 is coupled to the lid 104. A plurality of openings 112 are formed through the showerhead 110. The gas source 108 is in fluid communication with the process volume 114 via the port 106 and the openings 112.

A substrate support 116 is moveably disposed in the process volume 114 opposite the lid 104. The substrate support 116 includes a support body 130 disposed on a stem 118. The support body 130 includes a support surface 132 disposed opposite the stem 118 and facing the showerhead 110. In some embodiments, the process chamber 100 can include one or more ceramic components including lift pins, edge rings, isolators, heaters, electrostatic chucks, nozzles, cover wafers, and/or baffles, in which each of the one or more lift pins, edge rings, isolators, heaters, electrostatic chucks, nozzles, cover wafers, and/or baffles are a ceramic composition of the present disclosure. For example, the support body 130 can include a heater 136 or an electrostatic chuck. The heater 136 or electrostatic chuck is formed from a bulk material. In some embodiments, the heater 136 or electrostatic chuck may be a ceramic composition of the present disclosure.

The support surface 132 can include a plurality of mesas 134. An opening 120 is formed through the chamber body 102 between the lid 104 and the bottom 124. During operation, a substrate 101 is loaded onto the support surface 132 through the opening 120. An actuator 126 is coupled to the substrate support 116 to move the substrate support 116 toward and away from the showerhead 110 for loading and processing the substrate 101 thereon.

An RF mesh 122 is disposed within the support body 130. One or more portions of the RF mesh 122 are disposed in a plane that is substantially perpendicular to the support surface 132. The RF mesh 122 may be used to heat the substrate 101 or electrostatically chuck the substrate 101. The RF mesh 122 is a set distance away from the support surface 132. The RF mesh 122 is connected to one or more RF leads 127. The RF leads 127 are coupled to an RF power source 128. The RF power source 128 provides RF power to the RF mesh 122. While the heater 136 is shown above the RF mesh 122 in FIG. 1, the heater 136 and RF mesh may be oriented in any suitable orientation to heat the substrate 101, e.g., heater 136 below the RF mesh 122.

In some embodiments, the ceramic composition can include at least a first metal composition and a second metal composition. The first metal composition can include a Group 13 metal, e.g., aluminum, gallium, or indium. For example, the first metal composition can include an aluminum based composition. For example, the first metal composition can include an aluminum oxide, aluminum nitride, aluminum oxynitride, aluminum fluoride, and/or aluminum oxy-fluoride. For example, the first metal composition can include aluminum oxide. As a further example, the first metal composition can include aluminum nitride. Without being bound by theory, a first metal composition of aluminum oxide can provide increased hardness, while a first metal composition of aluminum nitride can provide increased electrical resistivity. Moreover, and without being bound by theory, a first metal composition including an oxyfluoride can enhanced fluorine etch resistivity, thereby promoting etch resistance in the ceramic composition.

The first metal composition can be present in the ceramic composition at about 0.1 mol % to about 99.9 mol %, e.g., about 0.1 mol % to about 90 mol %, about 20 mol % to about 80 mol %, about 0.1 mol % to about 40 mol %, about 80 mol % to about 99.9 mol %, or about 85 mol % to about 99.9 mol %. For example, the first metal composition can be present in the ceramic composition at about 85 mol % to about 99.9 mol %. As a further example, the metal composition can be present in the ceramic composition at about 0.1 mol % to about 40 mol %.

The second metal composition can include an alkaline-earth metal based composition, e.g., a Group 2 metal, such as beryllium, magnesium, calcium, strontium, barium, or radium. In some embodiments, the second metal composition can include a magnesium based composition. For example, the first metal composition can include a magnesium oxide, magnesium nitride, magnesium oxynitride, magnesium fluoride, and/or magnesium oxy-fluoride. For example, the second metal composition can include magnesium oxide. In some embodiments, the second metal composition can include calcium oxide. In some embodiments, the second metal composition can include strontium oxide. In some embodiments, the second metal composition can include barium oxide. Without being bound by theory, a second metal composition of magnesium oxide can provide a ceramic composition having a reduced vapor pressure and low wear rate for NF₃ plasma processing techniques operating at temperatures of less than 600° C. Moreover, and without being bound by theory, a second metal composition of calcium oxide, barium oxide, or strontium oxide can provide a ceramic composition having a reduced vapor pressure and low wear rate for NF₃ plasma processing techniques operating at temperatures of greater than 600° C. Additionally, and without being bound by theory, a second metal composition including an oxyfluoride can enhanced fluorine etch resistivity, thereby promoting etch resistance in the ceramic composition.

The second metal composition can be present in the ceramic composition at about 0.1 mol % to about 99.9 mol %, e.g., about 0.1 mol % to about 90 mol %, about 20 mol % to about 80 mol %, about 0.1 mol % to about 20 mol %, about 50 mol % to about 99.9 mol %, about 50 mol % to about 80 mol %, or about 55 mol % to about 99.9 mol %. For example, the first metal composition can be present in the ceramic composition at about 55 mol % to about 99.9 mol %. As a further example, the metal composition can be present in the ceramic composition at about 0.1 mol % to about 20 mol %.

The ceramic composition can include a third metal composition. The third metal composition can include a Group 3-12 metal. In some embodiments, the third metal composition can include a rare earth metal, e.g., erbium, lanthanum, samarium, yttrium, scandium, or a combination thereof. In some embodiments, the third metal composition can include a yttrium-based composition. For example, the third metal composition can include yttrium oxide, yttrium nitride, yttrium oxynitride, yttrium fluoride, and/or yttrium oxy-fluoride. In some embodiments, the third metal composition can include a lanthanum-based composition. For example, the third metal composition can include lanthanum oxide, lanthanum nitride, lanthanum oxynitride, lanthanum fluoride, and/or lanthanum oxy-fluoride. In some embodiments, the third metal composition can include an erbium-based composition. For example, the third metal composition can include erbium oxide, erbium nitride, erbium oxynitride, erbium fluoride, and/or erbium oxy-fluoride. In some embodiments, the third metal composition can include a samarium-based composition. For example, the third metal composition can include samarium oxide, samarium nitride, samarium oxynitride, samarium fluoride, and/or samarium oxy-fluoride. In some embodiments, the third metal composition can include a scandium-based composition. For example, the third metal composition can include scandium oxide, scandium nitride, scandium oxynitride, scandium fluoride, and/or scandium oxy-fluoride. Without being bound by theory, a ceramic composition including a third metal composition can include a reduced vapor pressure, a reduced leakage current, an enhanced electrical resistivity, a reduced dielectric loss to prevent radiofrequency self-heating, a reduced wear rate, and an enhanced dielectric breakdown voltage, when compared to conventional ceramic compositions. Without being bound by theory, a third metal composition including an oxyfluoride can enhanced fluorine etch resistivity, thereby promoting etch resistance in the ceramic composition.

The third metal composition can be present in the ceramic composition at about 0 mol % to about 40 mol %, e.g., about 0.1 mol % to about 40 mol %, about 0.1 mol % to about 30 mol %, about 0.1 mol % to about 25 mol %, about 0.1 mol % to about 20 mol %, or about 0.1 mol % to about 10 mol %. For example, the third metal composition can be present in the ceramic composition at about 0 mol % to about 40 mol %. As a further example, the third metal composition can be present in the ceramic composition at about 0 mol % to about 20 mol %. Without being bound by theory, a ceramic composition including about 0 mol % to about 40 mol % of a third metal composition of yttrium oxide can include enhanced durability to allow for operation at higher temperatures, e.g., greater than 600° C., without degradation, as compared to conventional ceramic compositions. Without being bound by theory, a ceramic composition including about 0 mol % to about 20 mol % of a third metal composition of yttrium oxide can include reduced vapor pressure for operation at lower temperatures, e.g., less than 600° C., without degradation, as compared to conventional ceramic compositions.

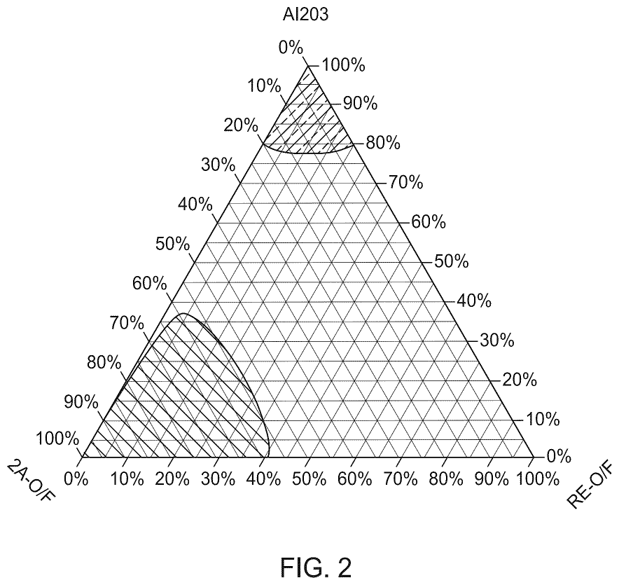

In some embodiments, the ceramic composition of the present disclosure can include about 80 mol % to about 99.9. mol % of a first metal composition of aluminum oxide, about 0.1 mol % to about 20 mol % of a second metal composition of magnesium oxide, and about 0.1 mol % to about 20 mol % of a third metal composition of yttrium oxide, where the combination of the first metal composition, second metal composition, and third metal composition does not exceed 100 mol %, as shown in FIG. 2. In some embodiments, the ceramic composition of the present disclosure can include about 85 mol % to about 99.9 mol % of a first metal composition of aluminum nitride, about 0.1 mol % to about 20 mol % of a second metal composition of magnesium oxide, and about 0 mol % to about 20 mol % of a third metal composition of yttrium oxide. In some embodiments, the ceramic composition of the present disclosure can include about 85 mol % to about 99.9 mol % of a first metal composition of aluminum oxynitride, about 0.1 mol % to about 20 mol % of a second metal composition of magnesium oxide, and about 0 mol % to about 20 mol % of a third metal composition of yttrium oxide. In some embodiments, the ceramic composition of the present disclosure can include about 85 mol % to about 99.9 mol % of a first metal composition of aluminum oxy-fluoride, about 0.1 mol % to about 20 mol % of a second metal composition of magnesium oxide, and about 0 mol % to about 20 mol % of a third metal composition of yttrium oxide. Without being bound by theory, a combination of aluminum oxide, yttrium oxide, and magnesium oxide can provide increased fluorine resistance compared to conventional bulk material compositions, e.g., aluminum nitride and/or aluminum oxide, thereby providing increased longevity for the ceramic composition. Moreover, and without being bound by theory, the combination of aluminum oxide, yttrium oxide, and magnesium oxide can provide a variety of chemical and physical properties by varying the ratio of mol % of the metal oxides, e.g., hardness, electrical resistivity, leakage current, or breakdown voltage.

The third metal composition is present in the ceramic composition at about 0.1 mol % to about 40 mol % when the composition comprises about 15 mol % to about 40 mol % of the first metal composition.

In some embodiments, the ceramic composition of the present disclosure can include about 0.1 mol % to about 40 mol % of a first metal composition of aluminum oxide, about 55 mol % to about 99.9 mol % of a second metal composition of magnesium oxide, and about 0 mol % to about 40 mol % of a third metal composition of yttrium oxide, where the third metal composition is present in the ceramic composition at about 0.1 mol % to about 40 mol % when the composition comprises about 15 mol % to about 40 mol % of the first metal composition. Without being bound by theory, as the first metal composition increases to above 15 mol %, an increase in the third metal composition can reduce and/or eliminate the formation of byproducts such as aluminum fluoride.

In some embodiments, the ceramic composition of the present disclosure can include about 0.1 mol % to about 40 mol % of a first metal composition of aluminum nitride, about 55 mol % to about 99.9 mol % of a second metal composition of magnesium oxide, and about 0 mol % to about 40 mol % of a third metal composition of yttrium oxide, where the third metal composition is present in the ceramic composition at about 0.1 mol % to about 40 mol % when the composition comprises about 15 mol % to about 40 mol % of the first metal composition. In some embodiments, the ceramic composition of the present disclosure can include about 0.1 mol % to about 40 mol % of a first metal composition of aluminum oxynitride, about 55 mol % to about 99.9 mol % of a second metal composition of magnesium oxide, and about 0 mol % to about 40 mol % of a third metal composition of yttrium oxide, where the third metal composition is present in the ceramic composition at about 0.1 mol % to about 40 mol % when the composition comprises about 15 mol % to about 40 mol % of the first metal composition.

In some embodiments, the ceramic composition of the present disclosure can include about 0.1 mol % to about 40 mol % of a first metal composition of aluminum oxy-fluoride, about 55 mol % to about 99.9 mol % of a second metal composition of magnesium oxide, and about 0 mol % to about 40 mol % of a third metal composition of yttrium oxide, where the third metal composition is present in the ceramic composition at about 0.1 mol % to about 40 mol % when the composition comprises about 15 mol % to about 40 mol % of the first metal composition. Without being bound by theory, a combination of aluminum oxide, yttrium oxide, and magnesium oxide can provide increased fluorine resistance compared to conventional bulk material compositions, e.g., aluminum nitride and/or aluminum oxide, thereby providing increased longevity for the ceramic composition. Moreover, and without being bound by theory, the combination of aluminum oxide, yttrium oxide, and magnesium oxide can provide a variety of chemical and physical properties by varying the ratio of mol % of the metal oxides, e.g., hardness, electrical resistivity, leakage current, or breakdown voltage.

Overall, embodiments of the present disclosure generally relate to ceramic compositions and methods of production. The ceramic compositions can be used as a bulk material for various components in high temperature NF₃ plasma processing chambers. The ceramic compositions can provide increased fluorine resistance compared to conventional bulk material compositions, e.g., aluminum nitride and/or aluminum oxide, thereby providing increased longevity for the substrate support. Moreover, the ceramic composition can allow for reduced manufacturing costs by reducing scaling complications during manufacturing. Additionally, the ceramic compositions can produce uniformity between two or more oxides, while maintaining a low porosity. The ceramic composition can manufactured to allow for controllable chemical and physical properties by varying the metal ratio of the metals in the ceramic composition, e.g., hardness, electrical resistivity, vapor pressure, leakage current, and/or breakdown voltage.

While the foregoing is directed to embodiments of the present disclosure, other and further embodiments of the disclosure may be devised without departing from the basic scope thereof, and the scope thereof is determined by the claims that follow.

What is claimed is:

1. A fluorine resistant ceramic composition comprising:
about 80 mol % to about 99.9 mol % of a first metal composition comprising an aluminum based composition selected from the group consisting of a nitride, oxynitride, oxide, and oxy-fluoride; and
about 0.1 mol % to about 20 mol % of a second metal composition comprising an alkaline-earth metal based composition selected from the group consisting of a nitride, oxynitride, oxide, oxy-fluoride, and fluoride.

2. The composition of claim 1, further comprising a third metal composition comprising a Group 3-12 metal composition.

3. The composition of claim 2, wherein the Group 3-12 metal composition comprises a rare earth metal comprising one or more of erbium, lanthanum, or samarium.

4. The composition of claim 2, wherein the Group 3-12 metal composition comprises a transition metal comprising one or more of yttrium or scandium.

5. The composition of claim 2, wherein the composition comprises:
about 80 mol % to about 99.8 mol % of the first metal composition;
about 0.1 mol % to about 19.9 mol % of the second metal composition; and
about 0.1 mol % to about to about 19.9 mol % of the third metal composition,
wherein the combination of the first metal composition, second metal composition, and third metal composition does not exceed 100 mol %.

6. The composition of claim 5, wherein:
the first metal composition is aluminum oxide;
the second metal composition is selected from the group consisting of magnesium oxide, calcium oxide, strontium oxide, and barium oxide; and
the third metal composition is selected from the group consisting of yttrium oxide, erbium oxide, lanthanum oxide, samarium oxide, and scandium oxide.

7. The composition of claim 6, wherein:
The first metal composition is aluminum oxide;
The second metal composition is magnesium oxide; and
The third metal composition is yttrium oxide.

8. The composition of claim 2, wherein at least one of the first metal composition, second metal composition, or third metal composition comprises one or more of an oxyfluoride or fluoride.

9. A fluorine resistant ceramic composition comprising:
about 0.1 mol % to about 40% mol % of a first metal composition comprising an aluminum based composition selected from the group consisting of a nitride, oxynitride, oxide, and oxy-fluoride;
about 55 mol % to about 99.9 mol % of a second metal composition comprising an alkaline-earth metal based composition selected from the group consisting of a nitride, oxynitride, oxide, oxy-fluoride, and fluoride; and
about 0 mol % to about 40 mol % of a third metal composition comprising a rare-earth metal based composition selected from the group consisting of a nitride, oxynitride, oxide, oxy-fluoride, and fluoride;
wherein the composition comprises about 0.1 mol % to about 40 mol % of the third metal composition when the composition comprises about 15 mol % to about 40 mol % of the first metal composition, and wherein the combination of the first metal composition, second metal composition, and third metal composition does not exceed 100 mol %.

10. The composition of claim 9, wherein the third metal composition comprises a Group 3-12 metal composition.

11. The composition of claim 10, wherein the Group 3-12 metal composition comprises a rare-earth metal comprising one or more of erbium, lanthanum, or samarium.

12. The composition of claim 10, wherein the Group 3-12 metal composition comprises a transition metal comprising one or more of yttrium or scandium.

13. The composition of claim 10, wherein the composition comprises:
about 15 mol % to about 40 mol % of the first metal composition;
about 55 mol % to about 84.9 mol % of the second metal composition; and
about 0.1 mol % to about to about 30 mol % of the third metal composition, wherein the combination of the first metal composition, second metal composition, and third metal composition does not exceed 100 mol %.

14. The composition of claim 10, wherein:
the first metal composition is aluminum oxide;
the second metal composition is selected from the group consisting of magnesium oxide, calcium oxide, strontium oxide, and barium oxide; and
the third metal composition is selected from the group consisting of yttrium oxide, erbium oxide, lanthanum oxide, samarium oxide, and scandium oxide.

15. The composition of claim 14, wherein:
the first metal composition is aluminum oxide;
the second metal composition is magnesium oxide; and
the third metal composition is yttrium oxide.

16. The composition of claim 10, wherein at least one of the first metal composition, second metal composition, or third metal composition comprises an oxyfluoride or fluoride.

17. A ceramic component, the ceramic component comprising a ceramic composition comprising:
about 0.1 mol % to about 40 mol % of a first metal composition comprising an aluminum based composition selected from the group consisting of a nitride, oxynitride, oxide, and oxy-fluoride;
about 55 mol % to about 99.9 mol % of a second metal composition comprising an alkaline-earth metal based composition selected from the group consisting of a nitride, oxynitride, oxide, oxy-fluoride, and fluoride; and
about 0 mol % to about 40 mol % of a third metal composition comprising an alkali metal based composition selected from the group consisting of a nitride, oxynitride, oxide, oxy-fluoride, and fluoride;
wherein the composition comprises about 0.1 mol % to about 40 mol % of the third metal composition when the composition comprises about 15 mol % to about 40 mol % of the first metal composition, and wherein the combination of the first metal composition, second metal composition, and third metal composition does not exceed 100 mol %.

18. The ceramic component of claim 17, wherein the ceramic component comprises a lift pin, a ring, an isolator, a heater, an electrostatic chuck, a baffle, a nozzle, a lid, a cover wafer, or other.

19. The ceramic component of claim 18, wherein the ceramic component comprises the heater.

20. The ceramic component of claim 19, wherein the ceramic component comprises the electrostatic chuck.
